(19) United States
(12) Patent Application Publication
(10) Pub. No.: US 2023/0108202 A1
(43) Pub. Date: Apr. 6, 2023

(54) OPTIMIZATION TOOL FOR SALES GAS SUPPLY, GAS DEMAND, AND GAS STORAGE OPERATIONS

(71) Applicant: Saudi Arabian Oil Company, Dhahran (SA)

(72) Inventors: Hanan H. Alomani, Tarout Island (SA); Hamza M. Aljamaan, Dammam (SA); Ammar H. Alali, Dhahran (SA)

(21) Appl. No.: 17/494,216

(22) Filed: Oct. 5, 2021

(51) Int. Cl. G06Q 10/06; G06Q 50/06; G06Q 10/10; G06F 3/0483; G06F 3/0484

(52) U.S. Cl. CPC G06Q 10/06313; G06F 3/0483; G06F 3/04847; G06Q 10/103; G06Q 10/06315; G06Q 50/06; G06Q 10/087

(57) ABSTRACT

Systems and methods include a computer-implemented method for optimizing supply, demand, and storage of gas. Project definitions for multiple projects of a sales gas supply-demand-storage operation are received by an optimization system configured to optimize gas supply, demand, and storage across the multiple projects. Current values including a date, a supply request, and a demand request are received by the optimization system for each project of the multiple projects. An analysis of the sales gas supply-demand-storage operation is performed by the optimization system using the project definitions and the current values. The analysis includes performing initial injections and production for the multiple projects based on surpluses and deficits.

### TECHNICAL FIELD

The present disclosure applies to techniques for managing sales gas supply, gas demand, and gas storage operations.

### BACKGROUND

Managing a company’s sales gas supply and demand with storage operations can be a challenging task. While certain steps of the process itself are fairly well-defined, numerous optimization cases can be particularly time-consuming. Also, operating multiple storage fields simultaneously can add another level of complexity due to the sequential nature of operations, which can require an iterative process to reach an optimum sales gas supply.

Gas storage operations can be established by running full-field simulation models for each storage reservoir. Although this process can provide accurate reservoir performance predications, the process can be inefficient for several reasons. First, the sequential nature of operating multiple storage projects requires field models to be run back-to-back, which can result in an extended runtime for each prediction case. Second, maximizing the total seasonal production and injection can require expensive computation time, and may be achieved in a time-consuming process of reassessing the monthly rates of one storage field model based on the results of another in order to honor all operational limits. In typical processes for gas storage operations, available reservoir modeling software packages do not offer a straightforward solution for such complex and iterative analyses. As a result, gas surplus and deficits can very often remain not fully met. Further, assessments can take several days to evaluate a very limited number of predication cases for a single supply-demand case. Weeks may be required to fully evaluate alternative supply stream feeds and future incremental projects timelines.

### SUMMARY

The present disclosure describes techniques that can be used for optimizing a sales gas supply-demand-storage operation. In some implementations, a computer-implemented method includes the following. Project definitions for multiple projects of a sales gas supply-demand-storage operation are received by an optimization system configured to optimize gas supply, demand, and storage across the multiple projects. Current values including a date, a supply request, and a demand request are received by the optimization system for each project of the multiple projects. An analysis of the sales gas supply-demand-storage operation is performed by the optimization system using the project definitions and the current values. The analysis includes performing initial injections and production for the multiple projects based on surpluses and deficits.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. Demand forecast can be reviewed at a corporate level and on a frequent basis. Managers or engineers can be asked to provide a gas supply stream from non-associated gas fields to complement the forecasted associated gas volumes and meet a company’s forecasted energy demand. The process can include producing existing fields as well as strategically planning incremental projects to meet increasing demands. Gas stream can then be optimized through gas storage operations in a number of underground reservoirs, where excess sales gas can be injected and, once a need arises, reproduced in order to defer high-cost incremental projects. Optimization can be defined, for example, as achieving a gas stream above a threshold percentage of use, efficiency, or key process indicators (KPIs). Gas supply-demand-storage optimization is defined by injecting/producing at the maximum allowable gas rate to minimize sales gas deficit and excess volumes for a current supply-demand case. This means that the optimization target is to have supply equal demand. To reach the optimum supply-demand balance, different scenarios can be analyzed by altering gas storage parameters (for example, as described with reference to FIG. 5). The scenarios include varying injection/production monthly rates, advancing/delaying commencement dates of injection/production phases, and/or shifting pre-storage field shut-in dates. Ultimately, the monthly balance should be as close to zero as possible. Numerous parameters of the different gas storage reservoirs can be integrated, evaluated, and optimized as needed with an ultimate goal of maximizing the total seasonal injection and production. An optimized gas stream can then be communicated to an appointed team to alter the supply stream by advancing and/or deferring incremental projects, and after which, the gas storage optimization can be carried out again. This process can be iterative and can continue until an optimum supply-demand balance is reached. Supply-demand cases can be comprehensively evaluated in a time-efficient manner. Streamlined optimization processes of gas storage operations can be used in order to achieve the optimum supply and demand balance in a shorter period of time. The processes can be used to integrate parameters of multiple gas storage fields; including reservoir health indicators, operating regulations, and surface facilities restrictions to provide an optimized gas supply in a short time

Sales gas supply and demand can be integrated with storage operations in multiple reservoirs in a single platform. This can enable acceleration of the turnaround time from receiving any new sales gas supply and a demand outlook to provide a sales gas balance while ensuring gas storage reservoirs are operated safely and efficiently. The process can provide a sales gas supply-demand optimization platform that targets enhancing the monetary value of non-associated gas fields’ production by maximizing condensate and byproducts at the minimum cost. Lastly, tools described in the present disclosure can be used by users who have no prior reservoir engineering experience, facilitating optimization exercises that can be carried out efficiently by less-experienced members of the workforce.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flowchart of an example of a gas storage project details input workflow for sales gas supply, gas demand, and gas storage operations, according to some implementations of the present disclosure.

FIG. 2 is a flowchart summarizing a workflow for defining supply-demand scenario (date, supply and demand) and performing optimization analysis of supply-demand and storage operations, according to some implementations of the present disclosure.

FIG. 3 is a flowchart of an example of an inject command workflow, according to some implementations of the present disclosure.

FIG. 4 is a flowchart of an example of a produce command workflow, according to some implementations of the present disclosure.

FIG. 5 is a screenshot showing an example of a graphical user interface (GUI) for interactively optimizing sales gas supply, gas demand, and gas storage operations, according to some implementations of the present disclosure.

FIG. 6 is a screenshot of an example of the GUI with a load profile tab selected, according to some implementations of the present disclosure.

FIG. 7 is a screenshot of an example of the GUI with a balance sheet tab selected, according to some implementations of the present disclosure.

FIG. 8 is a screenshot of an example of the GUI with a storage profile tab selected, according to some implementations of the present disclosure.

FIG. 9 is a screenshot of an example of the GUI with an inventory tab selected, according to some implementations of the present disclosure.

FIG. 10 is a screenshot of an example of the GUI with a PZ tab selected, according to some implementations of the present disclosure.

FIG. 11 is a screenshot showing an example of the GUI with export controls displayed, according to some implementations of the present disclosure.

FIG. 12 is a flowchart of an example of a method for optimizing a sales gas supply-demand-storage operation, according to some implementations of the present disclosure.

FIG. 13 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for optimizing a sales gas supply-demand-storage operation. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Techniques of the present disclosure can be implemented as a software tool, such as a desktop application, to optimize and balance sales gas supply and demand with gas storage operations. The software tool can streamline and optimize the decision-making process of gas storage operations to achieve an optimum supply-demand balance. Optimization can be achieved by injecting/producing at the maximum allowable gas rate to minimize sales gas deficit and excess volumes for a current supply-demand case. This means that the optimization target is to have supply equal demand. The software tool can be developed, for example, utilizing the MATLAB programming language. The software tool can automatically integrate parameters of multiple gas storage fields, including reservoir health indicators, operating regulations, and surface facility restrictions to provide an optimized gas supply. The results can be presented to a user using a graphical user interface (GUI) that offers a fully-featured monitoring window to display plots and information. The GUI can also offer an interactive experience, enabling the user to adjust key project parameters, with the results being recomputed and visualized in a matter of seconds.

In some implementations, a company’s monthly sales gas supply and demand scenario can be initially forecasted over a time period, for example, 20 years or longer. The stream of information can then be optimized through gas storage operations in a number of underground reservoirs. Given a sales gas supply-demand schedule, the optimization process can include the following. First, excess sales gas can be injected in the proper storage reservoir. Prospective sales gas deficits can be met by withdrawing from the proper storage reservoir. Gas storage project parameters for the projects are modified, if necessary, including modifying commencement dates and monthly rates for injection and production phases. An optimized sales gas supply stream is generated. Recommendations on the optimum start date of the incremental projects are provided to the strategic supply team to ensure eliminating any future deficit. The steps can be repeated until an optimum sales gas supply-demand balance is reached.

Through a review of simulation model results of different supply-demand schedules, it can be observed that the gas storage optimization is governed by a selected number of parameters and the process can be streamlined to optimize the balance using simple computations, without the need to run time-consuming simulation models. Therefore, a manual workflow was developed in Microsoft Excel as a first attempt to enhance the process. The completion time of a prediction case analysis was reduced from days to hours. Nonetheless, this method had a number of limitations. Manual adjustments and complex “if” statements had to be constantly introduced to the spreadsheets in order to implement any additional and/or special requirements. Moreover, for each case, the engineer could spend no less than one hour to run multiple Excel workflows, prepare data, generate tables and plot charts. After which, the injected and produced gas volumes into the storage reservoirs needed to be manually reviewed and, if necessary, modified to ensure that all constrains are honored. This required the engineer to have at least a basic understanding of all storage reservoirs’ flow capacity, operating regulations and surface facilities restrictions.

To eliminate human errors and expedite the optimization exercise for a faster response to a fluctuating sales gas future outlook, a system that implements the techniques of the present disclosure was introduced as an innovative solution to analyze sales gas supply-demand forecasts with a click of a button. The system can be a standalone desktop application developed using MATLAB programming language to automatically integrate parameters of multiple gas storage projects and provide optimized sales gas supply within seconds. When there is sales gas surplus or deficit to be met, the algorithm is programmed to operate storage fields and dictate to either inject into or produce from each and every reservoir based on a multidisciplinary set of parameters and assumptions; including reservoir health indicators, operating regulations, and surface facilities restrictions. In the crux of the present disclosure, its engine is equipped with necessary reservoir engineering tools and methods to ensure that the automated optimization workflow does not violate the physics and guarantee safe and viable gas storage operations from both surface and subsurface perspectives.

In some implementations, prior to constructing an algorithm, the following steps can be completed to determine a number of essential parameters for each gas storage reservoir. The historical reservoir’s production and/or injection volume data can be integrated with the pressure measurements obtained from wells to construct pressure vs. volume models. This allows the algorithm to monitor the gas inventory’s volume and pressure. A safe operating envelope can be defined as regulated by the operating conditions and restrictions of storage surface and subsurface conditions. A Cushion Gas Volume can be determined from the full-field simulation models by assessing the minimum gas volume necessary to maintain sufficient reservoir pressure and ensure optimum field deliverability. A Minimum Working Gas Volume can be determined based on the minimum wellhead pressure during production phase. A Maximum Working Gas Volume can be determined based on the maximum wellhead pressure during injection phase. Parameters can be evaluated against the conducted flow and geo-mechanics models and studies to ensure safe and economically viable gas storage operations (e.g. formation stability, sanding tendency, water production, and economic compression).

In addition to the described parameters, algorithms used the present disclosure can be developed to also honor numerous surface and subsurface constrains for each gas storage project. This information can be embedded within the programming code, and based on which, the algorithm determines key components to operate the storage fields.

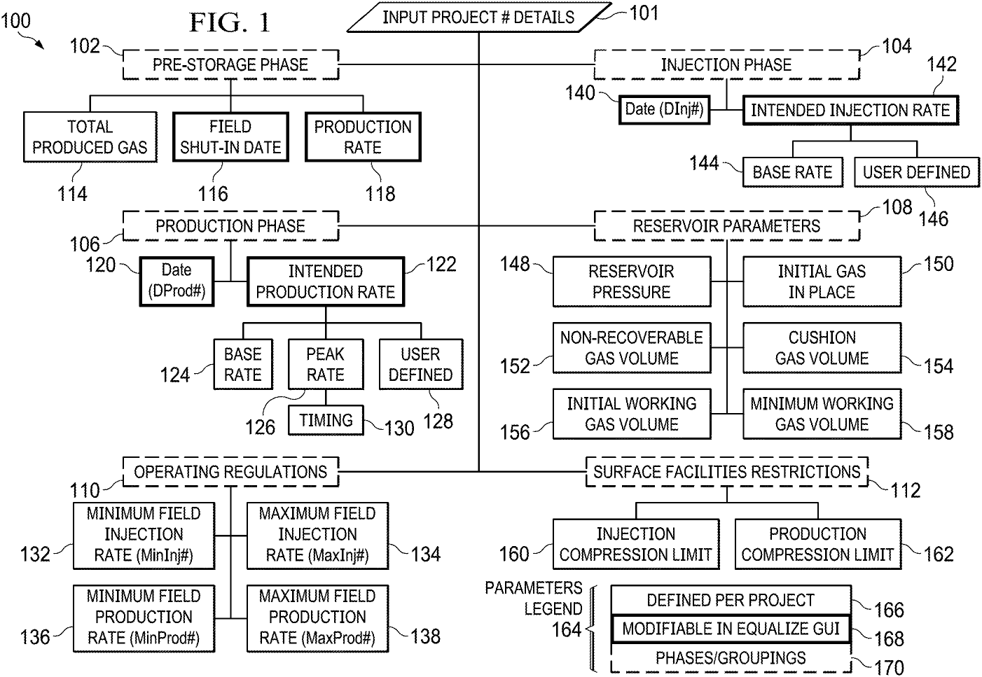

For the flowcharts presented with respect to FIGS. 1-4, the following assumptions were made. Supply and demand rates are provided on a monthly basis. Two gas storage projects are operated simultaneously: Project 1 and Project 2. Project 1 commences first and has the highest priority due to miscellaneous reasons such as lower operating cost.

FIG. 1 is a flowchart of an example of a gas storage project details input workflow 100 for sales gas supply, gas demand, and gas storage operations, according to some implementations of the present disclosure. The workflow 100 includes an input project details step 101 for defining and updating inputs used in stages/groupings of the project details input workflow 100. The stages/groupings include a pre-storage phase 102, an injection phase 104, a production phase 106, reservoir parameters 108, operating regulations 110, and surface facilities restrictions 112. Parameters used in the pre-storage phase 102 include a total produced gas 114, a field shut-in date 116, and a production rate 118. Parameters used in the injection phase 104 include a date 140 and an intended injection rate 142, including a base rate 144 and a user-defined rate 146. Parameters used in the production phase 106 include a date 120 and an intended injection rate 122 and includes a base rate 124, a peak rate 126, a user-defined rate 128, and a timing 130. Parameters used in the reservoir parameters 108 include a reservoir pressure 148, an initial gas in place 150, a non-recoverable gas volume 152, a cushion gas volume 154, an initial working gas volume 156, and a minimum working gas volume 158. Parameters used in the operating regulations 110 include a minimum field injection rate 132, a maximum field injection rate 134, a minimum field production rate 136, and a maximum field production rate 138. Parameters used in the surface facilities restrictions 112 include an initial compression limit 160 and a production compression limit 162. As shown in legend 164, defined-per-project elements 166 are depicted in FIG. 1 using standard boxes, and GUI-modifiable parameters 168 are shown using bolded boxes. Phases/groupings 170 (including elements 102-112) are shown using dashed lines.

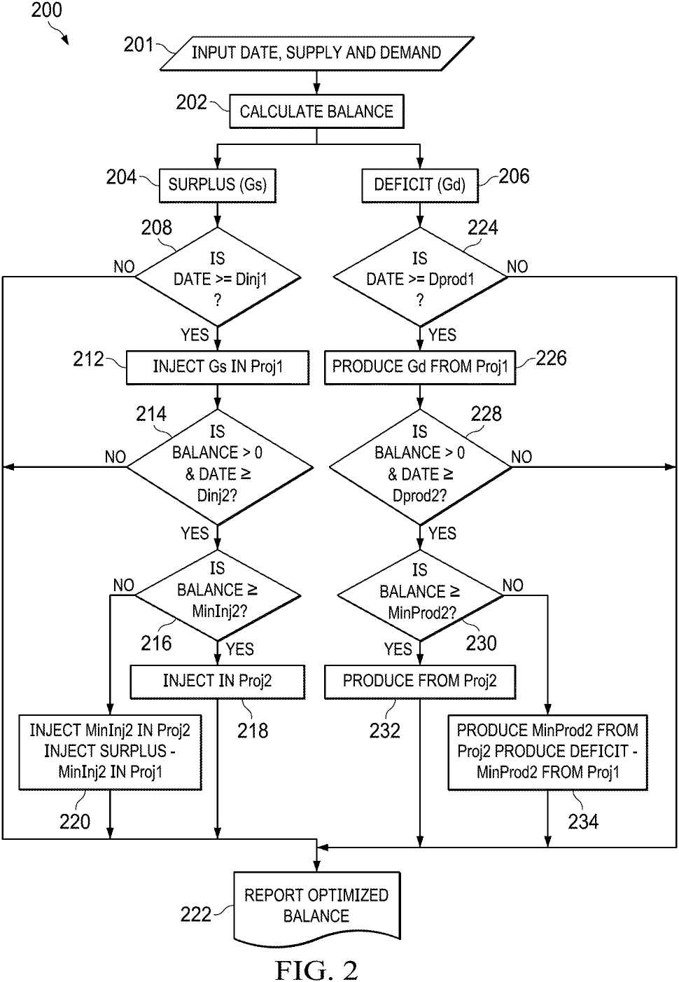

FIG. 2 is a flowchart summarizing a workflow 200 for defining date, supply and demand and performing optimization analysis of supply-demand and storage operations, according to some implementations of the present disclosure. The workflow 200 includes an input supply-demand case (date, supply, and demand) step 201. At 202, a balance is calculated. The calculation can result in a surplus 204 or a deficit 206.

When a surplus 204 exists, a date test is made at 208 to determine if the current date is greater than the injection date of Project 1 (Dinj1). If not, an optimized balance is reported at 222. If the current date is greater than the injection date, then injection 212 occurs for Project 1 (Proj 1). At 214, a test is made whether the balance is greater than zero and the date is greater than the injection date of Project 2 (Dinj2). If not, then the optimized balance is reported at 222. If the balance is greater than zero and the date is greater than or equal to the injection date of Project 2 (Dinj2), then a check is made at 216 whether the balance is greater than or equal to the minimum injection amount of Project 2 (MinInj2). If so, then gas is injected into Project 2 (Proj2) at 218. Otherwise, at 220, the minimum volume (MinInj2) is injected in Project 2, and a surplus minus the second injection amount (MinInj2) is injected into Project 1.

When a deficit 206 exists, a date test is made at 224 to determine if the current date is greater than a the production date of Project 1 (Dprod1). If not, then an optimized balance is reported at 222. If the current date is greater than the first production date (Dprod1), then gas is produced 226 from Project 1. At 228, a balance and test is made to determine if the balance is greater than zero and the current date is greater than or equal to the production date (Dprod2). If not, then an optimized balance is reported at 222. Otherwise, at 230, a test is made whether the balance is greater than the minimum production volume of Project 2 (MinProd2). If so, then gas is produced from Project 2 at 232. Otherwise, at 234, the minimum production volume (MinProd2) is produced from Project 2, and the deficit minus MinProd2is produced from Project 1.

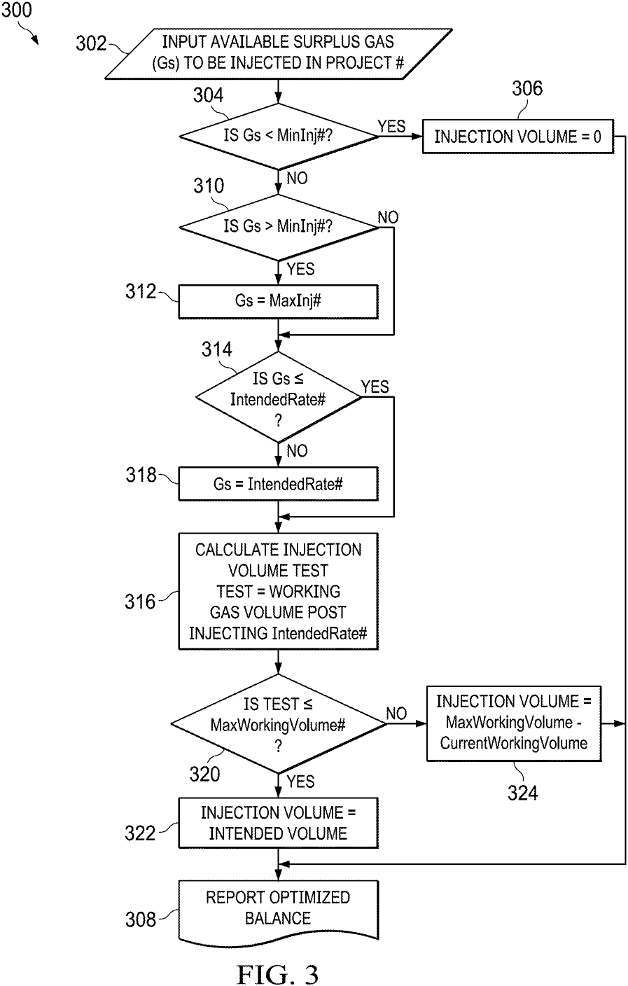

FIG. 3 is a flowchart of an example of an inject command workflow 300, according to some implementations of the present disclosure. For example, inject commands can be used at elements 212, 218 and 220. At 302, available surplus gas (Gs) to be injected into a project is input. At 304, a determination is made whether Gs is less than Minimum Field Injection Rate (Mininj#) 132 of the project. If Gs is less than the Mininj#, then at 306, an injection volume is set to zero, and an optimized balance is reported at 308. Otherwise, at 310, a determination is made whether Gs is greater than Maximum Field Injection Rate of the project (Maxinj#) 134. If the Gs is greater than Maxinj#, then Gs is set to Maxinj# at 312. At 314, a determination is made whether Gs is less than or equal to the Intended Injection Rate (IntendedRate#) 142. If Gs is not less than or equal to IntendedRate#, then Gs is set to IntendedRate# at 318. At 316, an injection volume test is calculated, and a test amount is set to the working gas volume post injecting IntendedRate#. At 320, a determination is made whether the Test amount is less than or equal to MaxWorkingVolume#. If so, then the injection volume is set to the intended volume at 322. Otherwise, at 324, the injection volume is set to MaxWorkingVolume minus the CurrentWorkingVolume.

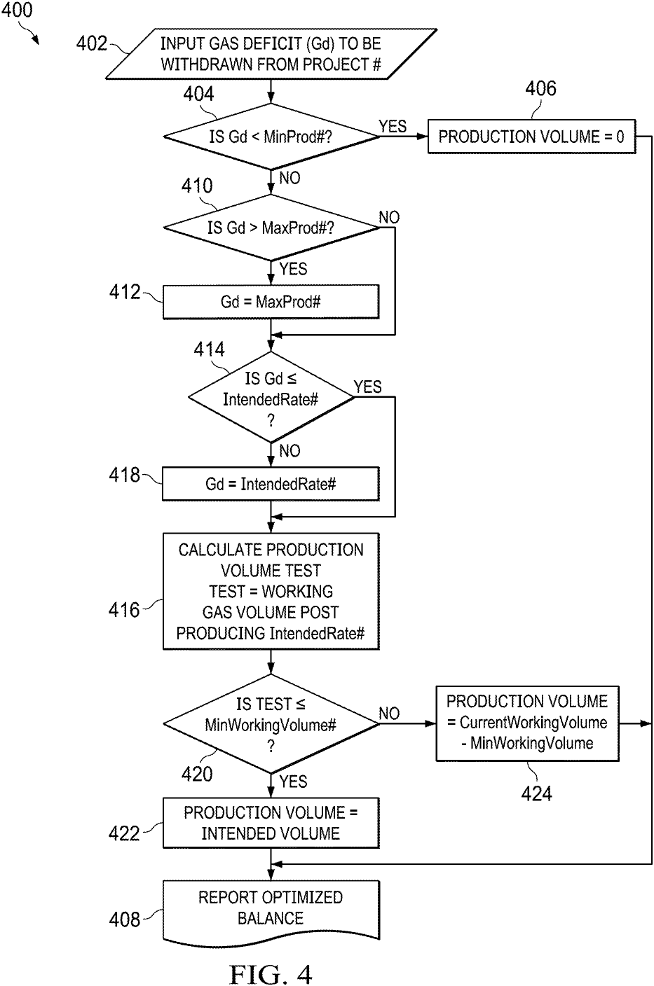

FIG. 4 is a flowchart of an example of a produce command workflow 400, according to some implementations of the present disclosure. A produce command can be utilized in elements 226, 232 and 234, for example. At 402, a gas deficit (Gd) to be withdrawn from a project is input. At 404, a determination is made whether Gd is less than the Minimum Field Production Rate of the project (MinProd#) 136. If the Gd is less than MinProd#, then at 406, a production volume is set to zero, and an optimized balance is reported at 408. Otherwise, at 410, a determination is made whether Gd is greater than the Maximum Field Production Rate of the project (MaxProd#) 138. If Gd is greater than theMaxProd#, then Gd is set to MaxProd# at 412. At 414, a determination is made whether Gd is less than or equal to the Intended Production Rate amount (IntendedRate#) 122. If Gd is not less than or equal to IntendedRate#, then Gd is set to IntendedRate# at 418. At 416, a production volume test is calculated and a test amount is set to the working gas volume post producing IntendedRate#. At 420, a determination is made whether the Test amount is less than or equal to MinWorkingVol# 158. If so, then the production volume is set to the intended volume at 422. Otherwise, at 424, the production volume is set to CurrentWorkingVolume minus the MinWorkingVolume.

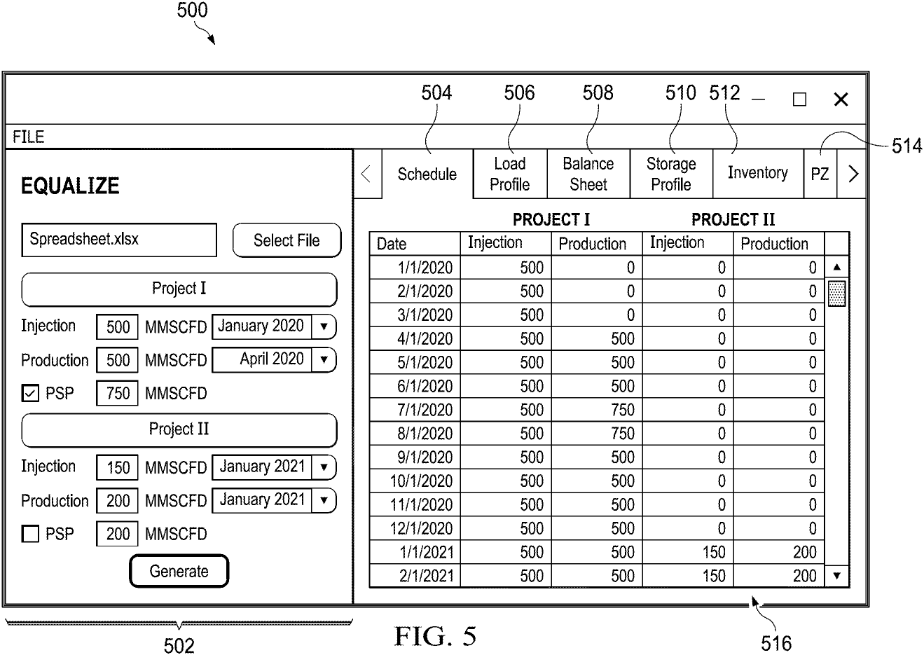

FIG. 5 is a screenshot showing an example of a graphical user interface (GUI) 500 for interactively optimizing sales gas supply, gas demand, and gas storage operations, according to some implementations of the present disclosure. The GUI 500 supports a fully-featured monitoring window to display key plots and information. The window has multiple tabs that can be navigated to view different tables and charts. For example, the GUI 500 includes a parameters area 502, a schedule tab 504, a load profile tab 506, a balance sheet tab 508, a storage profile tab 510, an inventory tab 512, and a PZ tab 514. The parameters area 502 can be used to define or select a sales gas supply and demand case, and to modify key project parameters for the case. As data in the parameters area 502 is input or changed by the user, information in the tabs 502-514 is automatically updated. A table 516 includes dates and injection/production volumes, in this example, for two projects.

FIG. 5 is a screenshot of an example of the GUI 500 with the schedule tab 504 selected, according to some implementations of the present disclosure. Upon loading a sales gas supply and demand case, an application that generates the GUI 500 can generate a default injection and production schedule 516 that initially uses default parameters for each gas storage project. Using the GUI 500, a user can modify the commencement date and base gas rate of both injection and production phases as well as the associated peak summer production (PSP) rate in the parameters area 502. User modifications can be reflected instantaneously on information displayed in the injection and production schedule 516. Additionally, users can modify the intended injection and production rates on a monthly basis by changing respective table cells for each project on the corresponding table.

The GUI 500 can provide an interactive experience to users, enabling the users to modify key project parameters. Based on the user modifications, such as changes made to table 516 and information in the parameters area 502, results can be recomputed and displayed in a matter of seconds. Use of the application and corresponding outputs can enhance the decision-making process, enabling the assessment of multiple cases in a significantly shorter period of time (as compared to not using the GUI 500).

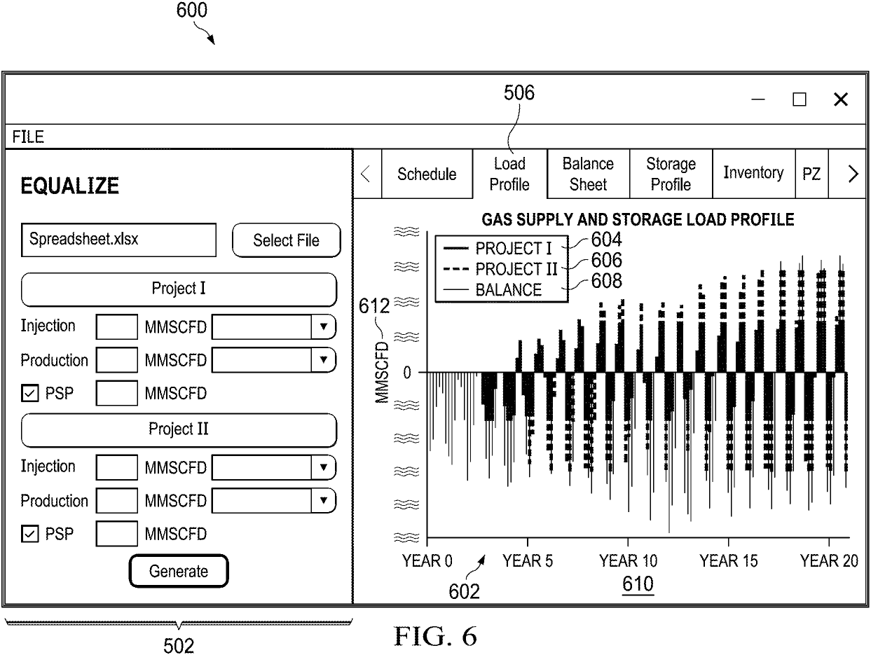

FIG. 6 is a screenshot 600 of an example of the GUI 500 with the load profile tab 506 selected, according to some implementations of the present disclosure. When the load profile tab 506 is selected, a gas supply and storage load profile plot 602 is presented, illustrating a sales gas supply-demand balance in chronological order and details regarding how each gas storage project is contributing to the overall optimization. Horizontal axis 610 represents time in years, and vertical axis 612 denotes the gas rate in millions of standard cubic feet per day (MMSCFD). Regions 608 show a gas supply-demand balance that cannot be met by gas storage operations. Positive values in the plot 602 represent gas deficits, and negative values represent gas surplus. The injected and produced volumes from each project of a first project 604 and a second project 606 are shown using different shading on the same plot, where positive values represent storage withdrawal rates and negative values represent storage injection rates. For example, the plot 602 shows an injection and production profile for the projects 604 and 606. Specifically, the plot 602 shows that Project I has optimized the balance by commencing production in Year 4 to meet a gas deficit, while a Project II production phase was not introduced until Year 8 to meet the growing sales gas demand. The heat-map grids 702 and 704 summarize sales gas supply-demand balance prior to and post gas storage optimization.

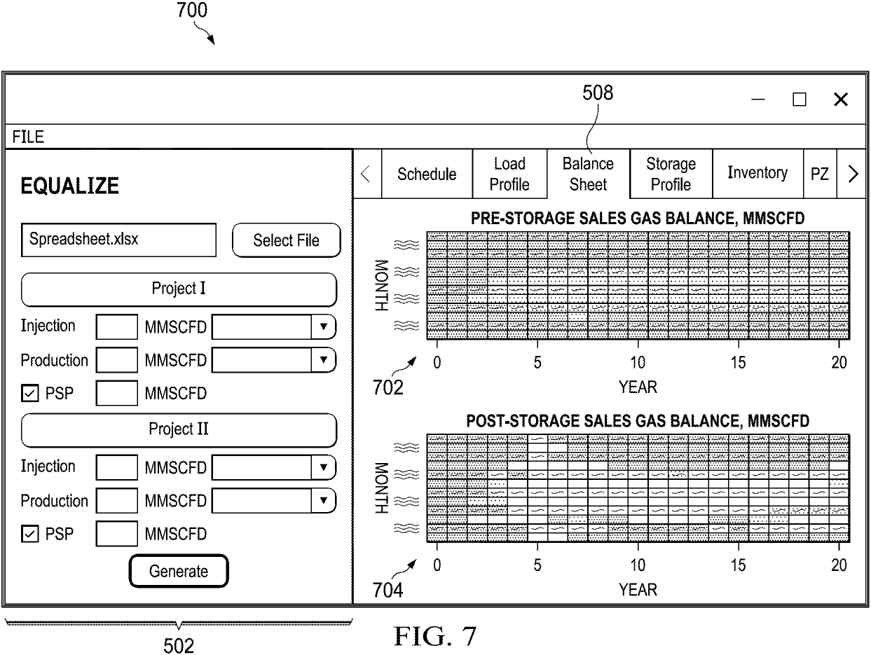

FIG. 7 is a screenshot 700 of an example of the GUI 500 with the balance sheet tab 508 selected, according to some implementations of the present disclosure. The screenshot 700 includes a pre-storage sales gas balance table 702 by month and a post-storage sales gas balance table 704 by month. By reviewing the values in the tables 702 and 704, a user can significantly reduce the duration of a case assessment.

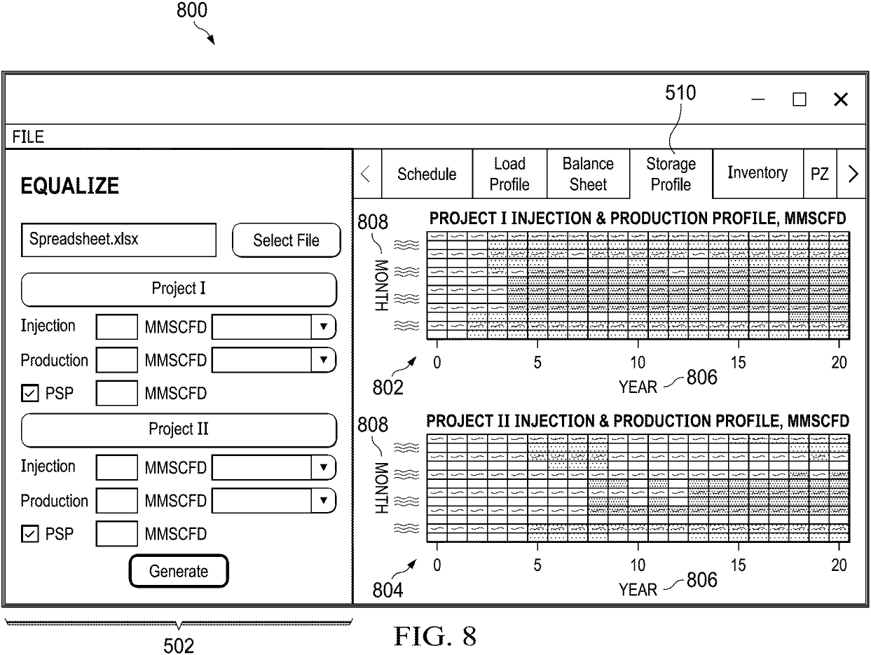

FIG. 8 is a screenshot 800 of an example of the GUI 500 with the storage profile tab 510 selected, according to some implementations of the present disclosure. When the storage profile tab 510 is selected, heat-map grids 802 and 804 summarize injection and withdrawal profiles and the months on the vertical axis. Each cell shows gas rate in MMSCFD for the respective date for the different gas storage projects. The heat-map displays the years on the horizontal axis. Dark-shaded cells denote gas production. Light-shaded cells denote gas injection. White cells denote a balance of production and injection. The heat-map grids 802 and 804 offer a visual representation of injection and production data which allows engineers and decision makers to quickly assess storage utilization and set further plans. The actions can be completed, for example, when conducting facility maintenance activities, well workovers, and evaluating the need of additional projects and increments.

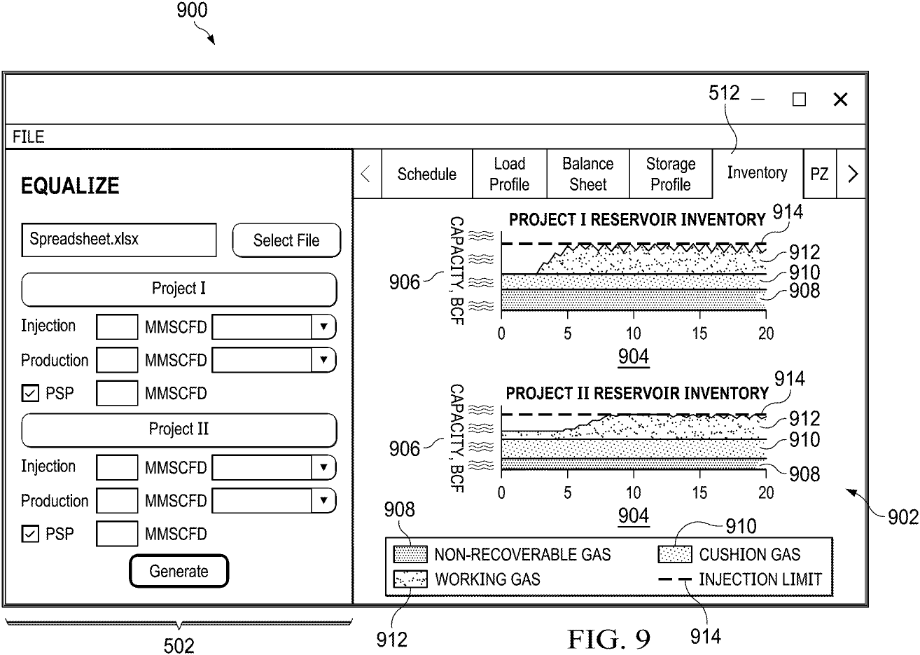

FIG. 9 is a screenshot 900 of an example of the GUI 500 with the inventory tab 512 selected, according to some implementations of the present disclosure. When the inventory tab 512 is selected or is active, inventory plots 902 for the different gas storage projects are displayed. The plots 902 illustrate the reservoir capacity and how the reservoir capacity is changing over time by gas storage operations. A horizontal axis 904 of the inventory plots 902 represents time in years, and a vertical axis 906 of the inventory plots 902 denotes the current gas in place in billions of cubic feet (BCF). A number of key storage reservoir components are presented on the plot, including a non-recoverable gas volume 908, a cushion gas volume 910, shown in light pink 912, a current working gas volume 912, and an injection limit 914. A maximum value of lower and upper working gas volume limits is indicated by the non-recoverable gas volume 908. The inventory plots can help an engineer to visualize how the storage reservoir capacity is being utilized throughout a project life. The plots 902 can also ensure that working gas volumes comply with the previously set constraints.

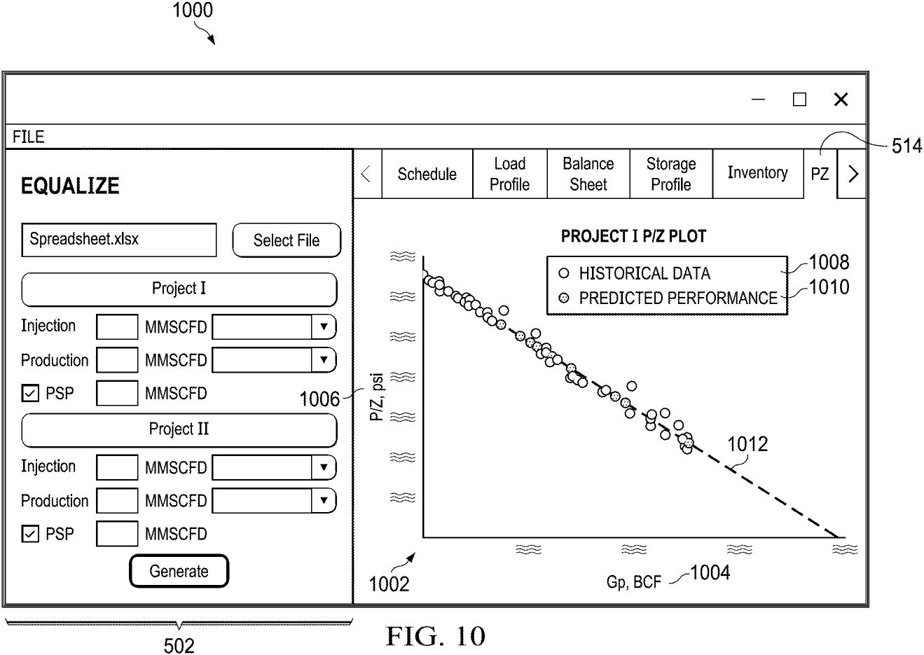

FIG. 10 is a screenshot 1000 of an example of the GUI 500 with the PZ tab 514 selected, according to some implementations of the present disclosure. When the PZ tab 514 is selected or active, pressure vs. volume model plots (PZ vs. Gp) 1002 for different gas storage projects can be displayed. The plots 1002 are based on gas reservoirs material balance and can be used to monitor the gas inventory’s pressure and volume during gas storage operations. A horizontal axis 1004 denotes the net produced gas volume in BCF (Gp), and a vertical axis 1006 represents the corresponding reservoir pressure over gas compressibility factor. Plots are constructed utilizing historical pressure measurements, indicated as white circles 1008, plotted according to their corresponding cumulative productions during gas blowdown prior to gas storage. An algorithm can be designed and used to generate a straight line fit 1012 to predict the reservoir performance, indicated as white circles 1010, at the end of each production and injection cycle.

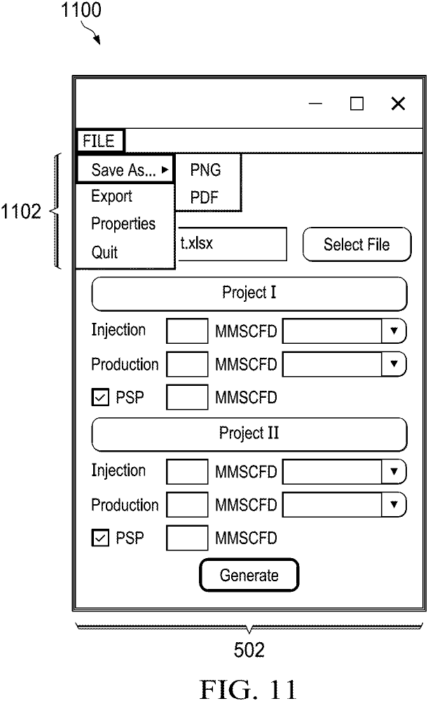

FIG. 11 is a screenshot 1100 showing an example of the GUI 500 with export controls 1102 displayed, according to some implementations of the present disclosure. For example, applications of the present disclosure can facilitate an export of optimized sales gas supply data, such as to a spreadsheet file. Plots and tables can also be exported as PNG or PDF files for fast and easy sharing among team members.

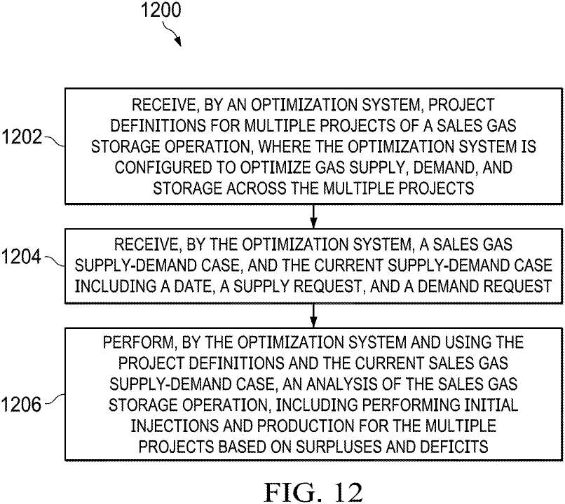

FIG. 12 is a flowchart of an example of a method 1200 for optimizing a sales gas supply-demand-storage operation, according to some implementations of the present disclosure. For clarity of presentation, the description that follows generally describes method 1200 in the context of the other figures in this description. However, it will be understood that method 1200 can be performed, for example, by any suitable system, environment, software, and hardware, or a combination of systems, environments, software, and hardware, as appropriate. In some implementations, various steps of method 1200 can be run in parallel, in combination, in loops, or in any order.

At 1202, project definitions for multiple projects of a sales gas storage operation are received by an optimization system configured to optimize gas supply, demand, and storage across the multiple projects. The project definitions (as described with reference to FIG. 1) can be received by the optimization system, for example. From 1202, method 1200 proceeds to 1204.

At 1204, a sales gas supply-demand case including a date, a supply request, and a demand request are received by the optimization system. The current supply-demand case (as described with reference to FIG. 2) can be received by the optimization system from a user through the GUI 502, for example. From 1204, method 1200 proceeds to 1206.

At 1206, an analysis of the sales gas storage operation is performed by the optimization system using the project definitions and the sales gas supply-demand case. The analysis includes performing initial injections and production for the multiple projects based on surpluses and deficits. For example, the analysis can be based on workflows described with reference to FIGS. 3 and 4. After 1206, method 1200 can stop.

In some implementations, method 120 can include optimization steps. Available surplus gas amounts to be injected into one or more first selected projects are received by the optimization system. For example, available surplus gas amounts can be determined using the workflow described with reference to FIG. 3. Gas deficit amounts to be withdrawn from one or more second selected projects are received by the optimization system. For example, the gas deficit amounts can be determined using the workflow described with reference to FIG. 4. The sales gas supply-demand-storage operation is optimized by the optimization system based on at least the available surplus gas amounts and the gas deficit amounts. The optimizing includes injecting the available surplus gas amounts and withdrawing the gas deficit amounts.

In some implementations, method 1200 further includes providing, in the GUI, tabs configured to display information linked to values received from the user. The tabs can include the schedule tab 504, the load profile tab 506, the balance sheet tab 508, the storage profile tab 510, the inventory tab 512, and the PZ tab 514. The schedule tab can be configured to display a schedule including default injection and production amounts. The load profile tab can be configured to display a supply-storage plot including profiles for gas supply and storage loads. The balance sheet tab can be configured to display balance tables including a pre-storage sales gas balances table and a post-storage sales gas balances table. The storage profile tab can be configured to display heat-map grids summarizing injection and withdrawal profiles. The inventory tab can be configured to display inventory plots showing changes in reservoir capacity over time. The PZ tab can be configured to display pressure-versus-volume model plots for different gas storage projects.

Applications that were developed and implemented for the present disclosure were based on various testing, experimentation, and refinement. Numerous old and new supply-demand scenarios were tested using techniques of the present disclosure, and the results were compared against other methods (mostly simulation models and developed spreadsheet-based workflows). The resulting applications that were developed and implemented were proven to provide comparable results with additional advantages of short computation time and minimal reservoir engineering experience.

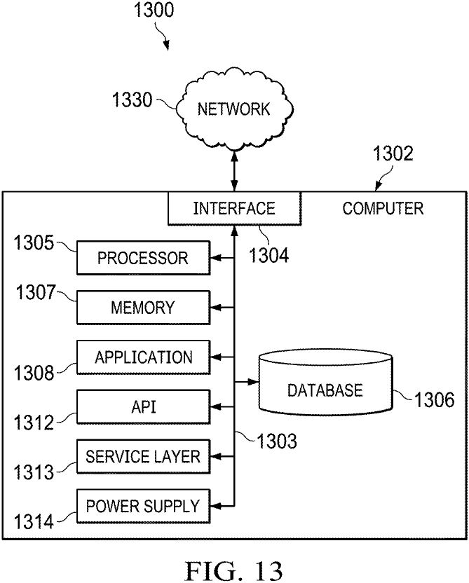

FIG. 13 is a block diagram of an example computer system 1300 used to provide computational functionalities associated with described algorithms, methods, functions, processes, flows, and procedures described in the present disclosure, according to some implementations of the present disclosure. The illustrated computer 1302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI).

The computer 1302 can serve in a role as a client, a network component, a server, a database, a persistency, or components of a computer system for performing the subject matter described in the present disclosure. The illustrated computer 1302 is communicably coupled with a network 1330. In some implementations, one or more components of the computer 1302 can be configured to operate within different environments, including cloud-computing-based environments, local environments, global environments, and combinations of environments.

At a top level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1330 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1303. In some implementations, any or all of the components of the computer 1302, including hardware or software components, can interface with each other or the interface 1304 (or a combination of both) over the system bus 1303. Interfaces can use an application programming interface (API) 1312, a service layer 1313, or a combination of the API 1312 and service layer 1313. The API 1312 can include specifications for routines, data structures, and object classes. The API 1312 can be either computer-language independent or dependent. The API 1312 can refer to a complete interface, a single function, or a set of APIs.

The service layer 1313 can provide software services to the computer 1302 and other components (whether illustrated or not) that are communicably coupled to the computer 1302. The functionality of the computer 1302 can be accessible for all service consumers using this service layer. Software services, such as those provided by the service layer 1313, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1312 or the service layer 1313 can be stand-alone components in relation to other components of the computer 1302 and other components communicably coupled to the computer 1302. Moreover, any or all parts of the API 1312 or the service layer 1313 can be implemented as child or sub-modules of another software module, enterprise application, or hardware module without departing from the scope of the present disclosure.

The computer 1302 includes an interface 1304. Although illustrated as a single interface 1304 in FIG. 13, two or more interfaces 1304 can be used according to particular needs, desires, or particular implementations of the computer 1302 and the described functionality. The interface 1304 can be used by the computer 1302 for communicating with other systems that are connected to the network 1330 (whether illustrated or not) in a distributed environment. Generally, the interface 1304 can include, or be implemented using, logic encoded in software or hardware (or a combination of software and hardware) operable to communicate with the network 1330. More specifically, the interface 1304 can include software supporting one or more communication protocols associated with communications. As such, the network 1330 or the interface’s hardware can be operable to communicate physical signals within and outside of the illustrated computer 1302.

The computer 1302 includes a processor 1305. Although illustrated as a single processor 1305 in FIG. 13, two or more processors 1305 can be used according to particular needs, desires, or particular implementations of the computer 1302 and the described functionality. Generally, the processor 1305 can execute instructions and can manipulate data to perform the operations of the computer 1302, including operations using algorithms, methods, functions, processes, flows, and procedures as described in the present disclosure.

The computer 1302 also includes a database 1306 that can hold data for the computer 1302 and other components connected to the network 1330 (whether illustrated or not). For example, database 1306 can be an in-memory, conventional, or a database storing data consistent with the present disclosure. In some implementations, database 1306 can be a combination of two or more different database types (for example, hybrid in-memory and conventional databases) according to particular needs, desires, or particular implementations of the computer 1302 and the described functionality. Although illustrated as a single database 1306 in FIG. 13, two or more databases (of the same, different, or combination of types) can be used according to particular needs, desires, or particular implementations of the computer 1302 and the described functionality. While database 1306 is illustrated as an internal component of the computer 1302, in alternative implementations, database 1306 can be external to the computer 1302.

The computer 1302 also includes a memory 1307 that can hold data for the computer 1302 or a combination of components connected to the network 1330 (whether illustrated or not). Memory 1307 can store any data consistent with the present disclosure. In some implementations, memory 1307 can be a combination of two or more different types of memory (for example, a combination of semiconductor and magnetic storage) according to particular needs, desires, or particular implementations of the computer 1302 and the described functionality. Although illustrated as a single memory 1307 in FIG. 13, two or more memories 1307 (of the same, different, or combination of types) can be used according to particular needs, desires, or particular implementations of the computer 1302 and the described functionality. While memory 1307 is illustrated as an internal component of the computer 1302, in alternative implementations, memory 1307 can be external to the computer 1302.

The application 1308 can be an algorithmic software engine providing functionality according to particular needs, desires, or particular implementations of the computer 1302 and the described functionality. For example, application 1308 can serve as one or more components, modules, or applications. Further, although illustrated as a single application 1308, the application 1308 can be implemented as multiple applications 1308 on the computer 1302. In addition, although illustrated as internal to the computer 1302, in alternative implementations, the application 1308 can be external to the computer 1302.

The computer 1302 can also include a power supply 1314. The power supply 1314 can include a rechargeable or non-rechargeable battery that can be configured to be either user- or non-user-replaceable. In some implementations, the power supply 1314 can include power-conversion and management circuits, including recharging, standby, and power management functionalities. In some implementations, the power-supply 1314 can include a power plug to allow the computer 1302 to be plugged into a wall socket or a power source to, for example, power the computer 1302 or recharge a rechargeable battery.

There can be any number of computers 1302 associated with, or external to, a computer system containing computer 1302, with each computer 1302 communicating over network 1330. Further, the terms “client,” “user,” and other appropriate terminology can be used interchangeably, as appropriate, without departing from the scope of the present disclosure. Moreover, the present disclosure contemplates that many users can use one computer 1302 and one user can use multiple computers 1302.

Described implementations of the subject matter can include one or more features, alone or in combination.

For example, in a first implementation, a computer-implemented method includes the following. Project definitions for multiple projects of a sales gas supply-demand-storage operation are received by an optimization system configured to optimize gas supply, demand, and storage across the multiple projects. Current values including a date, a supply request, and a demand request are received by the optimization system for each project of the multiple projects. An analysis of the sales gas supply-demand-storage operation is performed by the optimization system using the project definitions and the current values. The analysis includes performing initial injections and production for the multiple projects based on surpluses and deficits.

The foregoing and other described implementations can each, optionally, include one or more of the following features:

A first feature, combinable with any of the following features, where a number of project definitions and the sales gas supply-demand case are received by the optimization system from a user through a graphical user interface (GUI).

A second feature, combinable with any of the previous or following features, the method further including providing, in the GUI, tabs configured to display information linked to values received from the user, where the tabs include a schedule tab, a load profile tab, a balance sheet tab, a storage profile tab, an inventory tab, and PZ tab; where the schedule tab is configured to display a schedule including injection and production amounts per project; where the load profile tab is configured to display a supply-storage plot including profiles for gas supply and storage loads per project; where the balance sheet tab is configured to display balance tables including a pre-storage sales gas balances table and a post-storage sales gas balances table; where the storage profile tab is configured to display heat-map grids summarizing injection and withdrawal profiles per project; where the inventory tab is configured to display inventory plots showing changes in reservoir capacity over time per project; and where the PZ tab is configured to display pressure-versus-volume model plots per project.

A third feature, combinable with any of the previous or following features, the method further including: receiving, by the optimization system, available surplus gas amounts to be injected into one or more first selected projects; receiving, by the optimization system, gas deficit amounts to be withdrawn from one or more second selected projects; and optimizing, by the optimization system, the sales gas storage operation based on at least the available surplus gas amounts and the gas deficit amounts, where the optimizing includes injecting the available surplus gas amounts and withdrawing the gas deficit amounts.

A fourth feature, combinable with any of the previous or following features, where the project definitions include definitions for stages/groupings including a pre-storage phase, an injection phase, a production phase, reservoir parameters, operating regulations, and surface facilities restrictions.

A fifth feature, combinable with any of the previous or following features, the method further including providing, in response to performing the analysis of the sales gas storage operation, a graphical user interface for interactively optimizing sales gas supply, gas demand, and gas storage operations.

A sixth feature, combinable with any of the previous or following features, where the graphical user interface includes a monitoring window to display information from the optimization system, including a parameters area, a schedule tab, a load profile tab, a balance sheet tab, a storage profile tab, an inventory tab, and a PZ tab.

In a second implementation, a non-transitory, computer-readable medium stores one or more instructions executable by a computer system to perform operations including the following. Project definitions for multiple projects of a sales gas supply-demand-storage operation are received by an optimization system configured to optimize gas supply, demand, and storage across the multiple projects. Current values including a date, a supply request, and a demand request are received by the optimization system for each project of the multiple projects. An analysis of the sales gas supply-demand-storage operation is performed by the optimization system using the project definitions and the current values. The analysis includes performing initial injections and production for the multiple projects based on surpluses and deficits.

The foregoing and other described implementations can each, optionally, include one or more of the following features:

A first feature, combinable with any of the following features, where a number of project definitions and the sales gas supply-demand case are received by the optimization system from a user through a graphical user interface (GUI).

A second feature, combinable with any of the previous or following features, the operations further including providing, in the GUI, tabs configured to display information linked to values received from the user, where the tabs include a schedule tab, a load profile tab, a balance sheet tab, a storage profile tab, an inventory tab, and PZ tab; where the schedule tab is configured to display a schedule including injection and production amounts per project; where the load profile tab is configured to display a supply-storage plot including profiles for gas supply and storage loads per project; where the balance sheet tab is configured to display balance tables including a pre-storage sales gas balances table and a post-storage sales gas balances table; where the storage profile tab is configured to display heat-map grids summarizing injection and withdrawal profiles per project; where the inventory tab is configured to display inventory plots showing changes in reservoir capacity over time per project; and where the PZ tab is configured to display pressure-versus-volume model plots per project.

A third feature, combinable with any of the previous or following features, the operations further including: receiving, by the optimization system, available surplus gas amounts to be injected into one or more first selected projects; receiving, by the optimization system, gas deficit amounts to be withdrawn from one or more second selected projects; and optimizing, by the optimization system, the sales gas storage operation based on at least the available surplus gas amounts and the gas deficit amounts, where the optimizing includes injecting the available surplus gas amounts and withdrawing the gas deficit amounts.

A fourth feature, combinable with any of the previous or following features, where the project definitions include definitions for stages/groupings including a pre-storage phase, an injection phase, a production phase, reservoir parameters, operating regulations, and surface facilities restrictions.

A fifth feature, combinable with any of the previous or following features, the operations further including providing, in response to performing the analysis of the sales gas storage operation, a graphical user interface for interactively optimizing sales gas supply, gas demand, and gas storage operations.

A sixth feature, combinable with any of the previous or following features, where the graphical user interface includes a monitoring window to display information from the optimization system, including a parameters area, a schedule tab, a load profile tab, a balance sheet tab, a storage profile tab, an inventory tab, and a PZ tab.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Project definitions for multiple projects of a sales gas supply-demand-storage operation are received by an optimization system configured to optimize gas supply, demand, and storage across the multiple projects. Current values including a date, a supply request, and a demand request are received by the optimization system for each project of the multiple projects. An analysis of the sales gas supply-demand-storage operation is performed by the optimization system using the project definitions and the current values. The analysis includes performing initial injections and production for the multiple projects based on surpluses and deficits.

The foregoing and other described implementations can each, optionally, include one or more of the following features:

A first feature, combinable with any of the following features, where a number of project definitions and the sales gas supply-demand case are received by the optimization system from a user through a graphical user interface (GUI).

A second feature, combinable with any of the previous or following features, the operations further including providing, in the GUI, tabs configured to display information linked to values received from the user, where the tabs include a schedule tab, a load profile tab, a balance sheet tab, a storage profile tab, an inventory tab, and PZ tab; where the schedule tab is configured to display a schedule including injection and production amounts per project; where the load profile tab is configured to display a supply-storage plot including profiles for gas supply and storage loads per project; where the balance sheet tab is configured to display balance tables including a pre-storage sales gas balances table and a post-storage sales gas balances table; where the storage profile tab is configured to display heat-map grids summarizing injection and withdrawal profiles per project; where the inventory tab is configured to display inventory plots showing changes in reservoir capacity over time per project; and where the PZ tab is configured to display pressure-versus-volume model plots per project.

A third feature, combinable with any of the previous or following features, the operations further including: receiving, by the optimization system, available surplus gas amounts to be injected into one or more first selected projects; receiving, by the optimization system, gas deficit amounts to be withdrawn from one or more second selected projects; and optimizing, by the optimization system, the sales gas storage operation based on at least the available surplus gas amounts and the gas deficit amounts, where the optimizing includes injecting the available surplus gas amounts and withdrawing the gas deficit amounts.

A fourth feature, combinable with any of the previous or following features, where the project definitions include definitions for stages/groupings including a pre-storage phase, an injection phase, a production phase, reservoir parameters, operating regulations, and surface facilities restrictions.

A fifth feature, combinable with any of the previous or following features, the operations further including providing, in response to performing the analysis of the sales gas storage operation, a graphical user interface for interactively optimizing sales gas supply, gas demand, and gas storage operations.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user’s client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving, by an optimization system, project definitions for multiple projects of a sales gas storage operation, wherein the optimization system is configured to optimize gas supply, demand, and storage across the multiple projects;
receiving, by the optimization system, a sales gas supply-demand case including a date, a supply request, and a demand request; and
performing, by the optimization system using the project definitions and the sales gas supply-demand case, an analysis of the sales gas storage operation, including performing initial injections and production for the multiple projects based on surpluses and deficits.

2. The computer-implemented method of claim 1, wherein a number of project definitions and the sales gas supply-demand case are received by the optimization system from a user through a graphical user interface (GUI).

3. The computer-implemented method of claim 2, further comprising:
providing, in the GUI, tabs configured to display information linked to values received from the user, wherein the tabs include a schedule tab, a load profile tab, a balance sheet tab, a storage profile tab, an inventory tab, and PZ tab;
wherein the schedule tab is configured to display a schedule including injection and production amounts per project;
wherein the load profile tab is configured to display a supply-storage plot including profiles for gas supply and storage loads per project;
wherein the balance sheet tab is configured to display balance tables including a pre-storage sales gas balances table and a post-storage sales gas balances table;
wherein the storage profile tab is configured to display heat-map grids summarizing injection and withdrawal profiles per project;
wherein the inventory tab is configured to display inventory plots showing changes in reservoir capacity over time per project; and
wherein the PZ tab is configured to display pressure-versus-volume model plots per project.

4. The computer-implemented method of claim 1, further comprising:
receiving, by the optimization system, available surplus gas amounts to be injected into one or more first selected projects;
receiving, by the optimization system, gas deficit amounts to be withdrawn from one or more second selected projects; and
optimizing, by the optimization system, the sales gas storage operation based on at least the available surplus gas amounts and the gas deficit amounts, wherein the optimizing includes injecting the available surplus gas amounts and withdrawing the gas deficit amounts.

5. The computer-implemented method of claim 1, wherein the project definitions include definitions for stages/groupings including a pre-storage phase, an injection phase, a production phase, reservoir parameters, operating regulations, and surface facilities restrictions.

6. The computer-implemented method of claim 1, further comprising providing, in response to performing the analysis of the sales gas storage operation, a graphical user interface for interactively optimizing sales gas supply, gas demand, and gas storage operations.

7. The computer-implemented method of claim 6, wherein the graphical user interface includes a monitoring window to display information from the optimization system, including a parameters area, a schedule tab, a load profile tab, a balance sheet tab, a storage profile tab, an inventory tab, and a PZ tab.

8. A non-transitory, computer-readable medium storing one or more instructions executable by a computer system to perform operations comprising:
receiving, by an optimization system, project definitions for multiple projects of a sales gas storage operation, wherein the optimization system is configured to optimize gas supply, demand, and storage across the multiple projects;
receiving, by the optimization system, a sales gas supply-demand case including a date, a supply request, and a demand request; and
performing, by the optimization system using the project definitions and the sales gas supply-demand case, an analysis of the sales gas storage operation, including performing initial injections and production for the multiple projects based on surpluses and deficits.

9. The non-transitory, computer-readable medium of claim 8, wherein a number of project definitions and the sales gas supply-demand case are received by the optimization system from a user through a graphical user interface (GUI).

10. The non-transitory, computer-readable medium of claim 8, the operations further comprising:
providing, in the GUI, tabs configured to display information linked to values received from the user, wherein the tabs include a schedule tab, a load profile tab, a balance sheet tab, a storage profile tab, an inventory tab, and PZ tab;
wherein the schedule tab is configured to display a schedule including injection and production amounts per project;
wherein the load profile tab is configured to display a supply-storage plot including profiles for gas supply and storage loads per project;
wherein the balance sheet tab is configured to display balance tables including a pre-storage sales gas balances table and a post-storage sales gas balances table;
wherein the storage profile tab is configured to display heat-map grids summarizing injection and withdrawal profiles per project;
wherein the inventory tab is configured to display inventory plots showing changes in reservoir capacity over time per project; and
wherein the PZ tab is configured to display pressure-versus-volume model plots per project.

11. The non-transitory, computer-readable medium of claim 8, the operations further comprising:
receiving, by the optimization system, available surplus gas amounts to be injected into one or more first selected projects;
receiving, by the optimization system, gas deficit amounts to be withdrawn from one or more second selected projects; and
optimizing, by the optimization system, the sales gas storage operation based on at least the available surplus gas amounts and the gas deficit amounts, wherein the optimizing includes injecting the available surplus gas amounts and withdrawing the gas deficit amounts.

12. The non-transitory, computer-readable medium of claim 8, wherein the project definitions include definitions for stages/groupings including a pre-storage phase, an injection phase, a production phase, reservoir parameters, operating regulations, and surface facilities restrictions.

13. The non-transitory, computer-readable medium of claim 8, the operations further comprising providing, in response to performing the analysis of the sales gas storage operation, a graphical user interface for interactively optimizing sales gas supply, gas demand, and gas storage operations.

14. The non-transitory, computer-readable medium of claim 13, wherein the graphical user interface includes a monitoring window to display information from the optimization system, including a parameters area, a schedule tab, a load profile tab, a balance sheet tab, a storage profile tab, an inventory tab, and a PZ tab.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving, by an optimization system, project definitions for multiple projects of a sales gas storage operation, wherein the optimization system is configured to optimize gas supply, demand, and storage across the multiple projects;
receiving, by the optimization system, a sales gas supply-demand case including a date, a supply request, and a demand request; and
performing, by the optimization system using the project definitions and the sales gas supply-demand case, an analysis of the sales gas storage operation, including performing initial injections and production for the multiple projects based on surpluses and deficits.

16. The computer-implemented system of claim 15, wherein a number of project definitions and the sales gas supply-demand case are received by the optimization system from a user through a graphical user interface (GUI).

17. The computer-implemented system of claim 15, the operations further comprising:
providing, in the GUI, tabs configured to display information linked to values received from the user, wherein the tabs include a schedule tab, a load profile tab, a balance sheet tab, a storage profile tab, an inventory tab, and PZ tab;
wherein the schedule tab is configured to display a schedule including injection and production amounts per project;
wherein the load profile tab is configured to display a supply-storage plot including profiles for gas supply and storage loads per project;
wherein the balance sheet tab is configured to display balance tables including a pre-storage sales gas balances table and a post-storage sales gas balances table;
wherein the storage profile tab is configured to display heat-map grids summarizing injection and withdrawal profiles per project;
wherein the inventory tab is configured to display inventory plots showing changes in reservoir capacity over time per project; and
wherein the PZ tab is configured to display pressure-versus-volume model plots per project.

18. The computer-implemented system of claim 15, the operations further comprising:
receiving, by the optimization system, available surplus gas amounts to be injected into one or more first selected projects;
receiving, by the optimization system, gas deficit amounts to be withdrawn from one or more second selected projects; and
optimizing, by the optimization system, the sales gas storage operation based on at least the available surplus gas amounts and the gas deficit amounts, wherein the optimizing includes injecting the available surplus gas amounts and withdrawing the gas deficit amounts.

19. The computer-implemented system of claim 15, wherein the project definitions include definitions for stages/groupings including a pre-storage phase, an injection phase, a production phase, reservoir parameters, operating regulations, and surface facilities restrictions.

20. The computer-implemented system of claim 15, the operations further comprising providing, in response to performing the analysis of the sales gas storage operation, a graphical user interface for interactively optimizing sales gas supply, gas demand, and gas storage operations.
